(19) United States
(12) Patent Application Publication
(10) Pub. No.: US 2026/0339185 A1
(43) Pub. Date: Oct. 29, 2026

(54) ILLUMINATION SYSTEM AND PROJECTION APPARATUS

(71) Applicant: Coretronic Corporation, Hsin-Chu (TW)

(72) Inventors: Chin-Wen Huang, Hsin-Chu (TW); Pin-Jui Huang, Hsin-Chu (TW); Ming-Tsung Weng, Hsin-Chu (TW)

(73) Assignee: Coretronic Corporation, Hsin-Chu (TW)

(21) Appl. No.: 19/661,531

(22) Filed: Apr. 28, 2026

Related U.S. Application Data
(60) Provisional application No. 63/796,399, filed on Apr. 29, 2025.

(30) Foreign Application Priority Data
Jul. 28, 2025 (CN) 202511040385.9

(51) Int. Cl. G03B 21/20

(52) U.S. Cl. CPC G03B 21/204; G03B 21/2013; G03B 21/206; G03B 21/2066; G03B 21/208

(57) ABSTRACT

Provided are an illumination system and a projection apparatus. The illumination system includes a light source module, a wavelength conversion module, and a dichroic module. The light source module includes a first laser module, a second laser module, a third laser module, and a fourth laser module, providing a first laser beam, a second laser beam, a third laser beam, and a fourth laser beam, respectively. The wavelength conversion module includes a first wavelength conversion component and a second wavelength conversion component, configured to convert the first laser light into a first wavelength conversion light and convert the second laser light into a second wavelength conversion light, respectively. The dichroic module includes a first dichroic mirror, a second dichroic mirror, and a third dichroic mirror, which are respectively disposed on transmission paths of the first laser beam, the second laser beam, the third laser beam, and the fourth laser beam.

### CROSS-REFERENCE TO RELATED APPLICATION

This application claims the priority benefits of U.S. provisional application serial no. 63/796,399, filed on Apr. 29, 2025, and China application serial no. 202511040385.9, filed on Jul. 28, 2025. The entirety of each of the above-mentioned patent applications is hereby incorporated by reference herein and made a part of this specification.

### BACKGROUND

### Technical Field

The disclosure relates to an optical system and an apparatus, and particularly relates to an illumination system and a projection apparatus.

### Related Art

With the development of projection technology, users have increasingly higher demands for the image quality of projectors. In projector technology, certain models of projectors employ laser light sources collaborated with phosphor wheels (wavelength conversion wheels) as the source of illumination light beams. However, the projectors utilize the rotation of the phosphor wheel to sequentially provide light beams of different colors, which often leads to color breaking phenomena due to the slower response speed of the phosphor wheel. Specifically, when the rotation speed of the phosphor wheel is slower, the frequency of color switching per unit of time decreases, thereby causing the human eye to perceive rainbow artifacts (rainbow effect). However, if the rotation speed of the phosphor wheel is increased to mitigate the color breaking, then the noise generated by the motor becomes excessive.

Laser projectors utilizing red, green, and blue (RGB) laser light sources are gradually entering the mainstream projector market because of the characteristics of high color purity and ability to achieve wide color gamut coverage. However, the high coherence of laser light sources often results in laser speckle appearing on the projected images.

On the other hand, to enhance optical efficiency and image quality, hybrid light source technology has emerged as one of the latest projection technologies. In hybrid light source technology, the light source can simultaneously include, for example, at least one laser diode (LD), phosphor-converted light source, or at least one light-emitting diode (LED). The hybrid light source may effectively eliminate laser speckle while achieving advantages such as improved efficiency and enhanced color gamut.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection apparatus, which can effectively suppress color breaking and laser speckle phenomena to achieve superior optical effects. Other objectives and advantages of the disclosure can be further understood from the technical features disclosed in the disclosure.

To achieve one or part or all of the above objectives or other objectives, an embodiment of the disclosure provides an illumination system including a light source module, a wavelength conversion module, a dichroic module, and a light homogenizing module. The light source module includes a first laser module, a second laser module, a third laser module, and a fourth laser module, wherein the first laser module, the second laser module, the third laser module, and the fourth laser module provide a first laser beam, a second laser beam, a third laser beam, and a fourth laser beam, respectively. The wavelength conversion module includes a first wavelength conversion component and a second wavelength conversion component, wherein the first wavelength conversion component is disposed on a transmission path of the first laser light and is configured to convert the first laser light into a first wavelength conversion light, and the second wavelength conversion component is disposed on a transmission path of the second laser light and is configured to convert the second laser light into a second wavelength conversion light. The dichroic module includes a first dichroic mirror, a second dichroic mirror, and a third dichroic mirror, in which the first dichroic mirror is disposed on a transmission path of the first laser light from the first laser module to the first wavelength conversion component and is configured to reflect one of light in a first wavelength range and light outside the first wavelength range and allow the other to pass through, the second dichroic mirror is disposed on a transmission path of the second laser light from the second laser module to the second wavelength conversion component and is configured to reflect one of light in a second wavelength range and light outside the second wavelength range and allow the other to pass through, and the third dichroic mirror is disposed on transmission paths of the third laser light and the fourth laser light and is configured to transmit the third laser light and the fourth laser light to the second dichroic mirror. The first wavelength conversion light is filtered by the first dichroic mirror into a first color light in the first wavelength range, and the first dichroic mirror guides the first color light to be incident on the light homogenizing module. The second wavelength conversion light is filtered by the second dichroic mirror into a second color light in the second wavelength range, and the second dichroic mirror guides the second color light to be incident on the light homogenizing module. The third laser light and the fourth laser light are sequentially guided by the second dichroic mirror and the first dichroic mirror to be incident on the light homogenizing module. A color of the fourth laser light is the same as a color of the first color light or the second color light. The light homogenizing module homogenizes the first color light, the second color light, the third laser beam, and the fourth laser light to generate an illumination light.

To achieve one or part or all of the above objectives or other objectives, one embodiment of the disclosure provides a projection apparatus including the aforementioned illumination system, a light valve module, and a lens module. The illumination system is configured to provide an illumination light, and the light valve module is disposed on a transmission path of the illumination light and is configured to convert the illumination light into an image light. The lens module is disposed on a transmission path of the image light and is configured to project the image light outside the projection apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIGS. 1A, 1B, 1C, and 1D, are schematic views of optical paths of an illumination system according to an embodiment of the disclosure when first color light, second color light, third laser beam, and third color light are transmitted to a light homogenizing module, respectively.

FIG. 2 is a schematic view of the spectral range of the first laser beam, the second laser beam, and the third laser beam, the reflection band of a first dichroic mirror, the reflection band of a second dichroic mirror, the reflection band of a third dichroic mirror, and the spectrum of the fourth laser light in FIGS. 1A-1D.

FIG. 3 is a graph showing excitation spectra of a wavelength conversion region of a first wavelength conversion component and a wavelength conversion region of a second wavelength conversion component in FIGS. 1A-1D.

FIG. 4 is a schematic view of a projection apparatus according to an embodiment of the disclosure.

FIG. 5 is a light timing diagram of the projection apparatus in FIG. 4.

FIGS. 6A, and 6B are front schematic views of wavelength conversion modules in illumination systems according to two other embodiments of the disclosure.

FIG. 7 is a front schematic view of a wavelength conversion module in an illumination system according to yet another embodiment of the disclosure.

FIGS. 8A, 8B, 8C, and 8D, and are optical path schematic views of an illumination system according to still another embodiment of the disclosure when the first color light, the second color light, the third laser beam, and the third color light are transmitted to the light homogenizing module, respectively.

FIG. 9 is a simplified perspective schematic view of a positional relationship of optical paths between the third laser module and the light homogenizing module in an illumination system according to another embodiment of the disclosure.

FIG. 10 is a light timing diagram of a projection apparatus according to yet another embodiment of the disclosure.

FIG. 11 is an optical path schematic view of an illumination system according to still another embodiment of the disclosure when the third color light is transmitted to the light homogenizing module.

FIG. 12 is a schematic view of a light timing of a projection apparatus using the illumination system in FIG. 11.

FIG. 13 is a simple schematic view of an optical path of an illumination system according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an illumination system and a projection apparatus that may effectively suppress color breaking and laser speckle phenomena to achieve good optical effects.

Other objects and advantages of the disclosure may be further understood from the technical features disclosed by the disclosure.

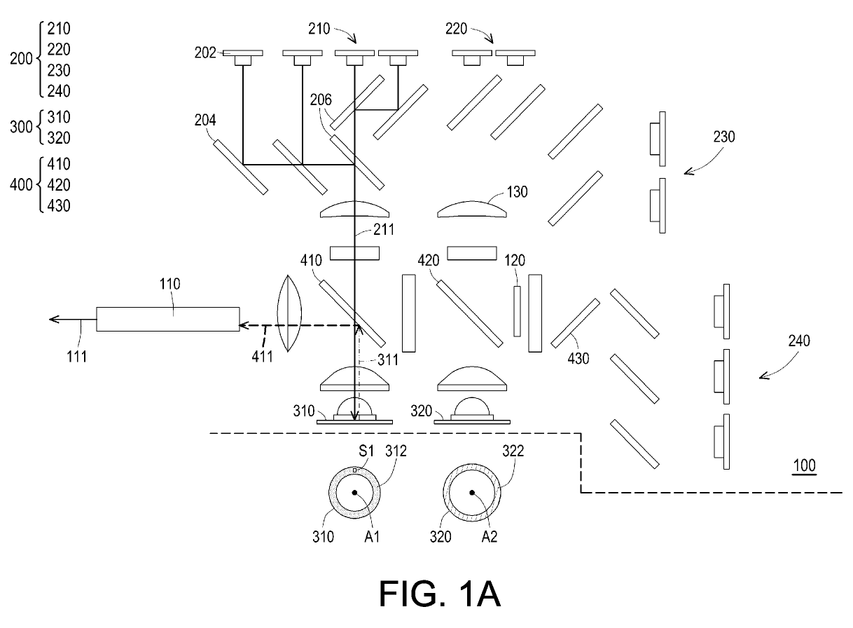

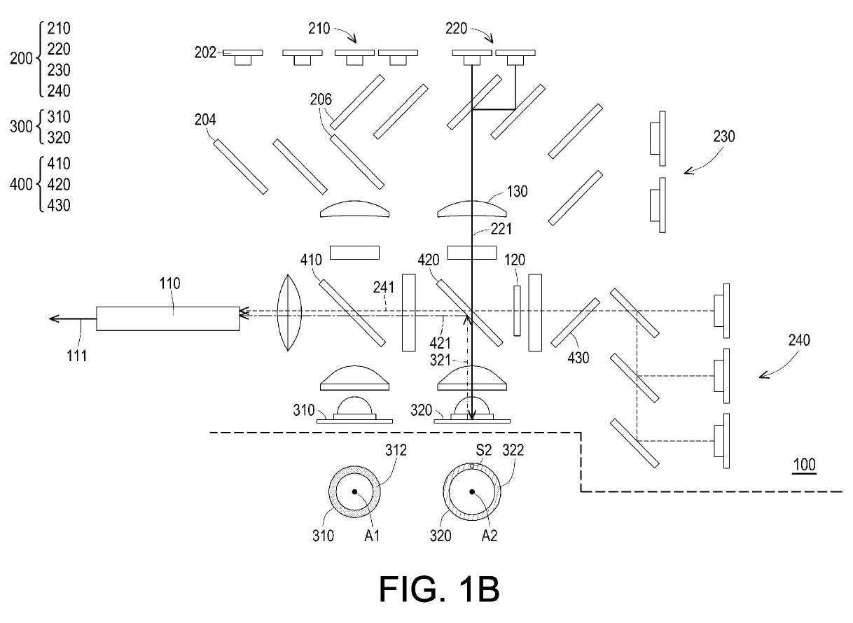

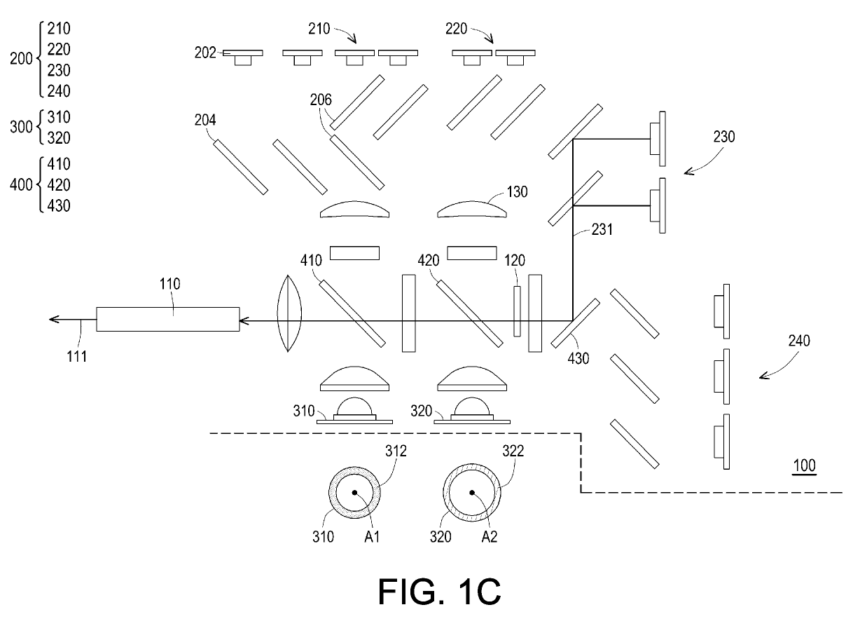

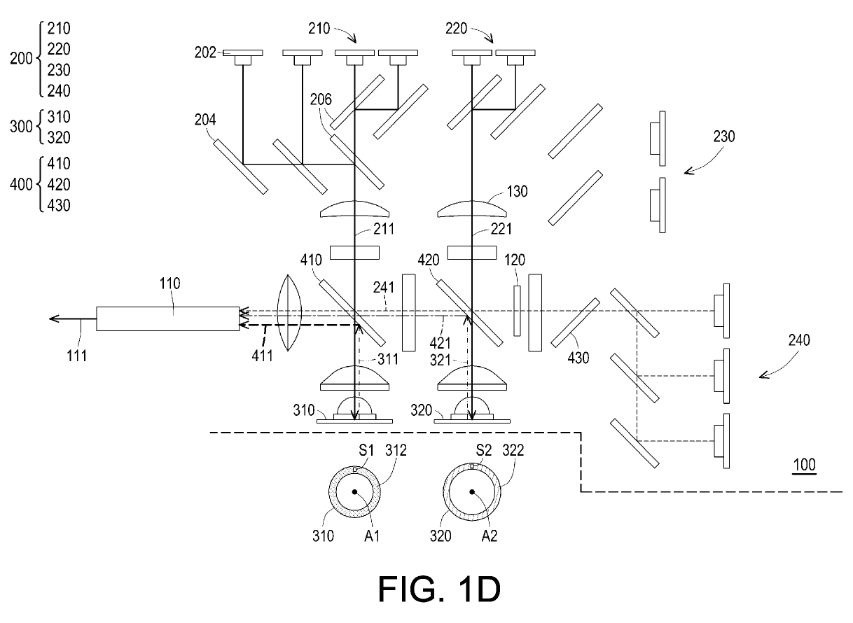

FIGS. 1A, 1B, 1C, and 1D, are schematic views of optical paths of an illumination system according to an embodiment of the disclosure when a first color light, a second color light, a third laser beam, and a third color light are transmitted to the light homogenizing module, respectively. Referring to FIGS. 1A-1D, an illumination system 100 of this embodiment includes a light source module 200, a wavelength conversion module 300, a dichroic module 400, and a light homogenizing module 110. The light source module 200 includes a first laser module 210, a second laser module 220, a third laser module 230, and a fourth laser module 240. The first laser module 210, the second laser module 220, the third laser module 230, and the fourth laser module 240 provide a first laser light 211, a second laser light 221, a third laser light 231, and a fourth laser light 241, respectively. The wavelength conversion module 300 includes a first wavelength conversion component 310 and a second wavelength conversion component 320. The first wavelength conversion component 310 is disposed on a transmission path of the first laser light 211 and is configured to convert the first laser light 211 into first wavelength conversion light 311. The second wavelength conversion component 320 is disposed on a transmission path of the second laser light 221 and is configured to convert the second laser light 221 into second wavelength conversion light 321. In this embodiment, the first wavelength conversion component 310 is not disposed on the transmission paths of the second laser light 221, the third laser light 231, and the fourth laser light 241, and the second wavelength conversion component 320 is not disposed on the transmission paths of the first laser light 211, the third laser light 231, and the fourth laser light 241.

In this embodiment, the first laser module 210, the second laser module 220, the third laser module 230, and the fourth laser module 240 may each include multiple laser diodes 202, one or more reflective mirrors 204, and one or more light combining components 206. The light combining components 206 and reflective mirrors 204 in each laser module may combine the light beams emitted by the multiple laser diodes 202 into a single laser light, such as the first laser light 211, the second laser light 221, the third laser light 231, or the fourth laser light 241. In this way, by adjusting the arrangement of the components in the first laser module 210, the second laser module 220, the third laser module 230, and the fourth laser module 240, the optical path may be translated or folded to reduce the overall volume of the system. Additionally, one or more lens elements 130 may be disposed on the transmission path of each laser beam, and the lens elements 130 may collimate or converge the laser beams. It should be noted that the quantities of the multiple laser diodes 202, the reflective mirrors 204, the light combining components 206, and the lens elements 130 used in the illumination system 100 may be adjusted based on actual requirements, and are not limited to the quantities of components illustrated in FIGS. 1A-1D. In the embodiment, the light combining component 206 may be a dichroic mirror, a beam splitter, or a half mirror, etc.

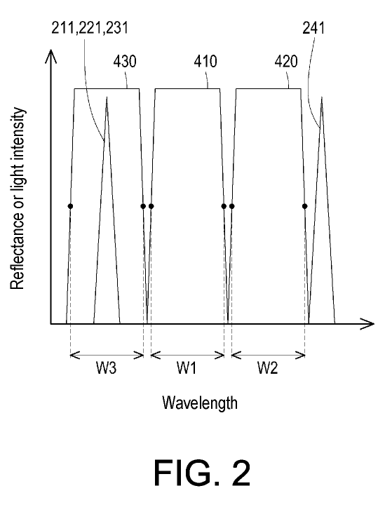

FIG. 2 is a schematic view of the spectral range of the first laser beam, the second laser beam, and the third laser beam, the reflection band of a first dichroic mirror, the reflection band of a second dichroic mirror, the reflection band of a third dichroic mirror, and the spectrum of the fourth laser light in FIGS. 1A-1D. Referring to FIGS. 1A-1D, and 2, the dichroic module 400 includes the first dichroic mirror 410, the second dichroic mirror 420, and the third dichroic mirror 430. The first dichroic mirror 410 is disposed on the transmission path of the first laser light 211 between the first laser module 210 and the first wavelength conversion component 310, and the first dichroic mirror 410 is configured to reflect one of light within a first wavelength range W1 and light outside the first wavelength range W1, and to allow the other of light within a first wavelength range W1 and light outside the first wavelength range W1 to pass through. In this embodiment, for example, the first dichroic mirror 410 reflects the light within the first wavelength range W1 and allows the light outside the first wavelength range W1 to pass through. The second dichroic mirror 420 is disposed on the transmission path of the second laser light 221 between the second laser module 220 and the second wavelength conversion component 320, and the second dichroic mirror 420 is configured to reflect one of light within a second wavelength range W2 and light outside the second wavelength range W2, and to allow the other of light within a second wavelength range W2 and light outside the second wavelength range W2 to pass through. In this embodiment, for example, the second dichroic mirror 420 reflects the light in the second wavelength range W2 and allows the light outside the second wavelength range W2 to pass through. The third dichroic mirror 430 is disposed on the transmission path of the third laser light 231 and the fourth laser light 241, and the third dichroic mirror 430 is configured to transmit the third laser light 231 and the fourth laser light 241 to the second dichroic mirror 420. In this embodiment, the third dichroic mirror 430 is configured to reflect the third laser light 231 from the third laser module 230 and allow the fourth laser light 241 from the fourth laser module 240 to pass through. In this embodiment, a third wavelength range W3 which is a reflection band of the third dichroic mirror 430 ranges from 435 to 485 nm, and a central wavelength of the fourth laser light 241 is greater than 636 nm. However, in other embodiments, the third dichroic mirror 430 may alternatively be configured to allow the third laser light 231 to pass through and to reflect the fourth laser light 241. Additionally, in this embodiment, both the third laser module 230 and the fourth laser module 240 are disposed on the same side of the second dichroic mirror 420. Furthermore, in this embodiment, the first laser light 211, the second laser light 221, and the third laser light 231 have the same central wavelength. In one embodiment, the wavelength range of the first laser light 211, the second laser light 221, and the third laser light 231 is in a range of 450 nm to 475 nm. However, in other embodiments, the first laser light 211 and the second laser light 221 have the same central wavelength, and the central wavelength of the first laser light 211 and the second laser light 221 is different from the central wavelength of the third laser light 231. In one embodiment, the first wavelength range W1 is from 491 to 582 nm, and the second wavelength range W2 is from 583 to 636 nm. In one embodiment, at least portion of the wavelength range of the first wavelength conversion light 311 falls outside the first wavelength range W1, and at least portion of the wavelength range of the second wavelength conversion light 321 falls outside the second wavelength range W2. Therefore, through the first dichroic mirror 410 and the second dichroic mirror 420, the first wavelength conversion light 311 and the second wavelength conversion light 321 may be filtered to produce first color light 411 and second color light 421 with higher color purity. In this embodiment, the spectral range of the first color light 411 and second color light 421 do not overlap. However, in other embodiments, the spectral range of the first color light 411 and the second color light 421 may partially overlap, for example, an overlapping portion of the spectral range of the first color light 411 and the second color light 421 is less than 15% of spectral range of the first color light 411 and less than 15% of spectral range of the second color light 421, respectively. Additionally, in this embodiment, each of a transmittance of the first dichroic mirror 410 and a transmittance of the second dichroic mirror 420 for the fourth laser light 241 is greater than 90%.

The first wavelength conversion light 311 is filtered by the first dichroic mirror 410 to become the first color light 411 having the first wavelength range W1, and the first dichroic mirror 410 guides the first color light 411 to be incident on the light homogenizing module 110. The second wavelength conversion light 321 is filtered by the second dichroic mirror 420 to become the second color light 421 having the second wavelength range W2, and the second dichroic mirror 420 guides the second color light 421 to be incident on the light homogenizing module 110. In this embodiment, the first dichroic mirror 410 filters the first wavelength conversion light 311 into the first color light 411 and reflects the first color light 411 to the light homogenizing module 110. The second dichroic mirror 420 filters the second wavelength conversion light 321 into the second color light 421 and reflects the second color light 421, and then the second color light 421 passes through the first dichroic mirror 410 and transmits to the light homogenizing module 110. The third laser light 231 and fourth laser light 241 are sequentially guided by the second dichroic mirror 420 and the first dichroic mirror 410 to be incident on the light homogenizing module 110. The color of the fourth laser light 241 is the same as the color of the first color light 411 or the second color light 421. In this embodiment, for example, the first color light 411 is a green light, the second color light 421 is a red light, each of the first laser light 211, the second laser light 221, and the third laser light 231 is a blue laser light, and the fourth laser light 241 is a red laser light. The light homogenizing module 110 homogenizes the first color light 411, the second color light 421, the third laser light 231, and the fourth laser light 241 to generate an illumination light 111. In this embodiment, the light homogenizing module 110 is, for example, a light integrating rod or a lens array. Additionally, at any given time point, the illumination light 111 includes at least one of the first color light 411, the second color light 421, the third laser light 231, and the fourth laser light 241.

The bottom two ring-shaped structures in FIGS. 1A-1D schematically illustrate front views of the first wavelength conversion component 310 and the second wavelength conversion component 320, respectively. A wavelength conversion region 312 of the first wavelength conversion component 310 and a wavelength conversion region 322 of the second wavelength conversion component 320 are both annular (ring-shaped), for example, in an O-ring shape. Additionally, FIGS. 1A-1D schematically illustrate the position of a light spot S1 where the first laser light 211 illuminates the first wavelength conversion component 310 and the position of a light spot S2 where the second laser light 221 illuminates the second wavelength conversion component 320.

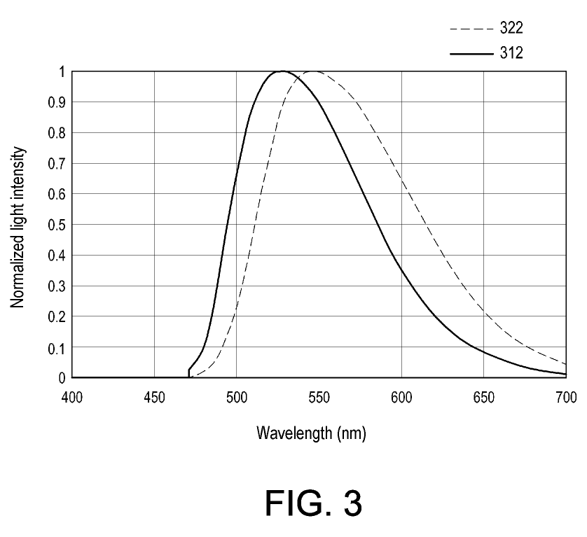

FIG. 3 is a graph showing excitation spectra of the wavelength conversion region of the first wavelength conversion component and the wavelength conversion region of the second wavelength conversion component in FIGS. 1A-1D. Referring to FIGS. 1A-1D, and 3, in this embodiment, an excitation spectrum of the wavelength conversion region 312 of the first wavelength conversion component 310 is different from an excitation spectrum of the wavelength conversion region 322 of the second wavelength conversion component 320. In one embodiment, the wavelength conversion region 312 of the first wavelength conversion component 310 includes, for example, green phosphor and is adapted to be excited to generate a green light, and the wavelength conversion region 322 of the second wavelength conversion component 320 includes, for example, yellow phosphor and is adapted to be excited to generate a yellow light. The excitation spectral range of the wavelength conversion regions 312 and 322 are illustrated in FIG. 3. However, in other embodiments, the excitation spectrum of the wavelength conversion region 312 of the first wavelength conversion component 310 may be the same as the excitation spectrum of the wavelength conversion region 322 of the second wavelength conversion component 320, for example, both the wavelength conversion region 312 and the wavelength conversion region 322 include green phosphor, or both include yellow phosphor. In this embodiment, the first wavelength conversion component 310 is configured to rotate about a central axis A1 thereof, so that the first laser light 211 illuminates different positions of the wavelength conversion region 312 at different time points to avoid overheating the first wavelength conversion component 310. Additionally, the second wavelength conversion component 320 is configured to rotate about a central axis A2 thereof, so that the second laser light 221 illuminates different positions of the wavelength conversion region 322 at different time points to avoid overheating the second wavelength conversion component 320. In other words, in this embodiment, both the first wavelength conversion component 310 and the second wavelength conversion component 320 are rotatable and movable components. For example, each of the first wavelength conversion component 310 and the second wavelength conversion component 320 may be a phosphor wheel. The rotation speeds of the first wavelength conversion component 310 and the second wavelength conversion component 320 may be the same or different. However, in other embodiments, the first wavelength conversion component 310 and the second wavelength conversion component 320 may also be stationary components (fixed components).

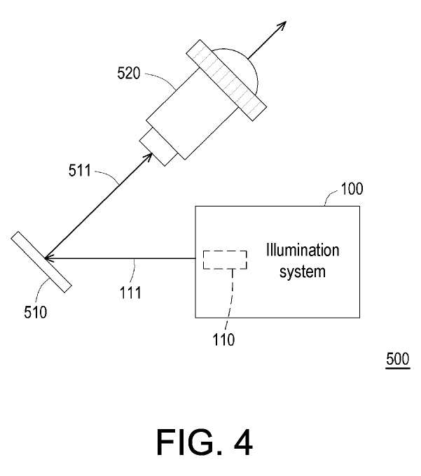

FIG. 4 is a schematic view of a projection apparatus according to an embodiment of the disclosure. A projection apparatus 500 of this embodiment includes the aforementioned illumination system 100, a light valve module 510, and a lens module 520. The illumination system 100 is configured to provide an illumination light 111, and the light valve module 510 is disposed on the transmission path of the illumination light 111 and is configured to convert the illumination light 111 into an image light 511. The lens module 520 is disposed on the transmission path of the image light 511 and is configured to project the image light 511 to the outside of the projection apparatus 500, for example, to be projected onto a screen or an imaging surface outside the projection apparatus 500 to form a projected image. In this embodiment, the light valve module 510 is, for example, a digital micro-mirror device (DMD), a liquid-crystal-on-silicon panel (LCOS panel), or other suitable spatial light modulator, which is adapted to modulate the illumination light 111 into the image light 511. The lens module 520 includes, for example, a combination of one or more optical lens elements having refractive power, such as various combinations of non-planar lens elements including biconcave lens elements, biconvex lens elements, concave-convex lens elements, convex-concave lens elements, plano-convex lens elements, and plano-concave lens elements. In one embodiment, the lens module 520 may further include an optical reflective mirror to project the image light 511 from the light valve module 510 to a projection target in a reflective manner. The embodiments of the disclosure do not limit the configuration and type of the lens module 520.

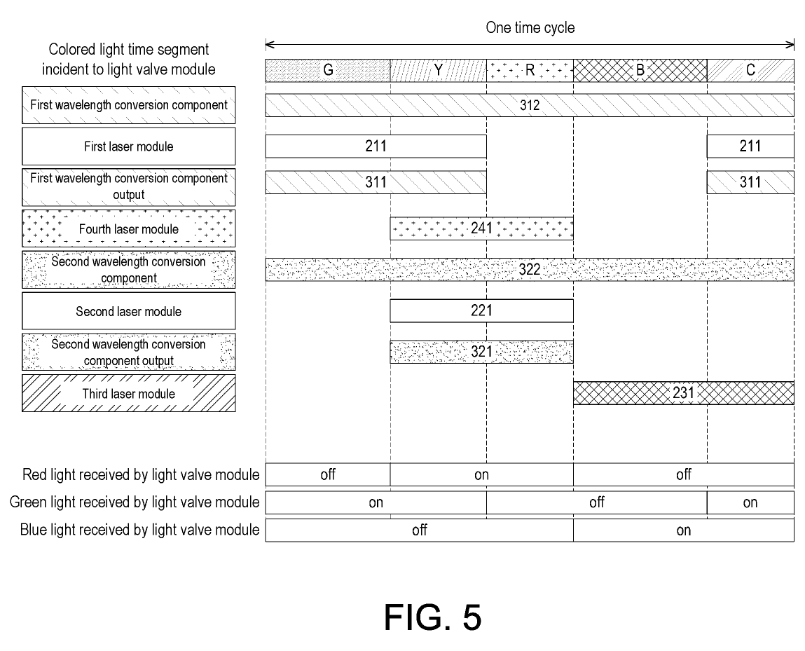

FIG. 5 is a light timing diagram of the projection apparatus in FIG. 4. Referring to FIGS. 1A-1D, and 5 simultaneously, in this embodiment, the first laser module 210, the second laser module 220, and the third laser module 230 are configured to provide the first laser light 211, the second laser light 221, and the third laser light 231 in different time intervals, respectively. The fourth laser module 240 provides the fourth laser light 241 during a time interval in which the first laser module 210 provides the first laser light 211 or during a time interval in which the second laser module 220 provides the second laser light 221. In this embodiment, the fourth laser light 241 is, for example, red, the first color light 411 is, for example, green, and the second color light 421 is, for example, red. Since the color of the fourth laser light 241 is the same as the color of the second color light 421, the fourth laser module 240 provides the fourth laser light 241 during the time interval in which the second laser module 220 provides the second laser light 221. That is, where the color of the fourth laser light 241 is the same as the color of the second color light, the time interval in which the fourth laser module 240 provides the fourth laser light 241 is identical to the time interval in which the second laser module 220 provides the second laser light 221. In other embodiments, where the color of the fourth laser light 241 is the same as the color of the first color light 411, for example, both the fourth laser light 241 and the first color light 411 are green light. In this case, the fourth laser module 240 provides the fourth laser light 241 during the time interval in which the first laser module 210 provides the first laser light 211, but the disclosure is not limited thereto.

In the light timing diagram of FIG. 5, when the illumination light 111 is the green light, it is represented by "G"; when the illumination light 111 is the red light, it is represented by "R"; when the illumination light 111 is the blue light, it is represented by "B". The timing of the G time interval in FIG. 5 corresponds to the state shown in FIG. 1A, where the first laser module 210 is turned on, while the second laser module 220, the third laser module 230, and the fourth laser module 240 are turned off. The first laser light 211 provided by the first laser module 210 passes through the first dichroic mirror 410 and illuminates the first wavelength conversion component 310, thereby generating the light spot S1 on the wavelength conversion region 312. The first wavelength conversion component 310 converts the incident first laser light 211 into the first wavelength conversion light 311, and transmits the first wavelength conversion light 311 to the first dichroic mirror 410. The first dichroic mirror 410 filters the first wavelength conversion light 311 to obtain the first color light 411 (green light) with a higher color purity, and directs (for example, reflects) the first color light 411 to the light homogenizing module 110. In the timing of the G time interval, the illumination light 111 received by the light valve module 510 is the green first color light 411.

The timing of the R time interval in FIG. 5 corresponds to the state shown FIG. 1B, where the second laser module 220 and the fourth laser module 240 are turned on, while the first laser module 210 and the third laser module 230 are turned off. The second laser light 221 provided by the second laser module 220 passes through the second dichroic mirror 420 and illuminates the second wavelength conversion component 320, thereby generating the light spot S2 on the wavelength conversion region 322. The second wavelength conversion component 320 converts the incident second laser light 221 into the second wavelength conversion light 321, and transmits the second wavelength conversion light 321 to the second dichroic mirror 420. The second dichroic mirror 410 filters the second wavelength conversion light 321 to obtain the second color light 421 (red light) with a higher color purity, and directs (for example, reflects) the second color light 421 to the first dichroic mirror 410, so that the second color light 421 passes through the first dichroic mirror 410 and is transmits to the light homogenizing module 110. The fourth laser light 241 provided by the fourth laser module 240, after being guided (for example, passing) through the third dichroic mirror 430, is sequentially guided through the second dichroic mirror 420 and the first dichroic mirror 410 to be incident on the light homogenizing module 110. In the timing of the R time interval, the illumination light 111 received by the light valve module 510 includes the red second color light 421 and the red fourth laser light 241.

The B time interval in FIG. 5 corresponds to the state shown in FIG. 1C, where the third laser module 230 is turned on, while the first laser module 210, the second laser module 220, and the fourth laser module 240 are turned off. The third laser light 231 provided by the third laser module 230, after being guided (for example, reflected) through the third dichroic mirror 430, is sequentially guided by the second dichroic mirror 420 and the first dichroic mirror 410 and to be incident on the light homogenizing module 110. In the timing of the B time interval, the illumination light 111 received by the light valve module 510 includes the blue third laser light 231.

In this embodiment, the G time interval, the R time interval, and the B time interval may constitute one time cycle. However, in other embodiments, one time cycle may further include a timing of a Y time interval in which the illumination light 111 is the yellow light, and the timing of the Y time interval is between the G time interval and the R time interval. The timing of the Y time interval in FIG. 5 corresponds to the state shown FIG. 1D, where the first laser module 210, the second laser module 220, and the fourth laser module 240 are turned on, while the third laser module 230 is turned off. That is to say, for the fourth laser module 240, the time interval during which the fourth laser module 240 provides the fourth laser light 241 partially overlaps with the time interval during the first laser module 210 and the second laser module 220 simultaneously provide the first laser light 211 and the second laser light 221. In the timing of the Y time interval, the first color light 411, the second color light 421, and the fourth laser light 241 are all guided to the light homogenizing module 110 to form the third color light (yellow light). As such, the illumination light 111 received by the light valve module 510 is the third color light (yellow light), which includes the green first color light 411, the red second color light 421, and the red fourth laser light 241.

In other embodiments, the time interval during which the third laser module 230 provides the third laser light 231 partially overlaps with the time interval during which the first laser module 210 provides the first laser light 211 or during which the second laser module 220 provides the second laser light 221, such that the third laser light 231 and the first color light 411, or the third laser light 231 and the second color light 421, are combined to form the fourth color light. In FIG. 5, one time cycle may further include a C time interval located after the timing of the B time interval. At this time, the first laser module 210 and the third laser module 230 are turned on, while the second laser module 220 and the fourth laser module 240 are turned off. That is to say, for the third laser module 230, the time interval during which the third laser module 230 provides the third laser light 231 partially overlaps with the time interval during which the first laser module 210 provides the first laser light 211. In the timing of the C time interval, the third laser light 231 and the first color light 411 are both guided to the light homogenizing module 110 to form the fourth color light (cyan light). As such, the illumination light 111 received by the light valve module 510 is the fourth color light (cyan light), which includes the blue third laser light 231 and the green first color light 411. In another embodiment not shown in FIG. 5, one time cycle may further include an M time interval between the R time interval and the B time interval. At this time, the second laser module 220 and the third laser module 230 are turned on, while the first laser module 210 and the fourth laser module 240 are turned off. That is to say, for the third laser module 230, the time interval during which the third laser module 230 provides the third laser light 231 partially overlaps with the time interval during which the second laser module 220 provides the second laser light 221. In the timing of the M time interval, the third laser light 231 and the second color light 421 are both guided to the light homogenizing module 110 to form the fourth color light (magenta light). As such, the illumination light 111 received by the light valve module 510 is the fourth color light (magenta light), which includes the blue third laser light 231 and the red second color light 421.

In the illumination system 100 and the projection apparatus 500 of this embodiment, the first laser module 210, the first wavelength conversion component 310, and the first dichroic mirror 410 are configured to generate the first color light 411, and the second laser module 220, the second wavelength conversion component 320, and the second dichroic mirror 420 are configured to generate the second color light 421. Therefore, the first color light 411, the second color light 421, and the third laser light 231 can be independently turned on and turned off without being subject to hardware limitations such as motors or color wheels, thereby significantly increasing the color update rate without color breaking phenomena. In conventional projection apparatuses, phosphor wheels having different color segments are employed. While increasing the number of color segments improves the color update rate, the number of boundaries between different color segments also increases. In the conventional technology, the light valve is turned off when the laser light illuminates the boundaries to avoid incorrect colors from being incident on the light valve, but this lowers the brightness of the image light modulated by the light valve. In contrast, in this embodiment, the wavelength conversion region 312 of the first wavelength conversion component 310 and the wavelength conversion region 322 of the second wavelength conversion component 320 are both in complete O-ring shapes (continuous O-ring shape) without different color segments. Therefore, the problem of brightness reduction in the image light caused by boundaries between different color segments is avoided. Thus, the illumination system 100 and the projection apparatus 500 of this embodiment can achieve superior brightness.

Furthermore, in the illumination system 100 and the projection apparatus 500 of this embodiment, the color of the fourth laser light 241 is the same as the color of the first color light 411 or the second color light 421. The first color light 411 and the second color light 421 are converted by the wavelength conversion components and are filtered out through the first dichroic mirror 410 and the second dichroic mirror 420 respectively, such that no laser speckle occurs. Therefore, by the combination of the first color light 411 and the fourth laser light 241 or the combination of the second color light 421 and the fourth laser light 241, the laser speckle phenomena can be effectively suppressed. The high coherence of laser light is likely to cause laser speckle phenomena, of which the red laser light and the green laser light are more severe. Therefore, in this embodiment, the red second color light 421 is combined with the red fourth laser light 241 to effectively suppress the laser speckle phenomena caused by the fourth laser light 241. In this embodiment, the illumination system 100 may further include a diffusion component 120 disposed in the transmission path of the fourth laser light 241, for example, positioned between the fourth laser module 240 and the second dichroic mirror 420, to suppress the laser speckle phenomena caused by the fourth laser light 241. The diffusion component 120 may be a stationary component (fixed component) or a movable component. For example, the diffusion component 120 may be a diffusion wheel, a diffusion film, or a diffusion plate. Moreover, the first color light 411 filtered out through the first dichroic mirror 410 and the second color light 421 filtered out through the second dichroic mirror 420 may have a higher color purity to purify the color points of the green light and the red light, thereby effectively improving the color gamut coverage.

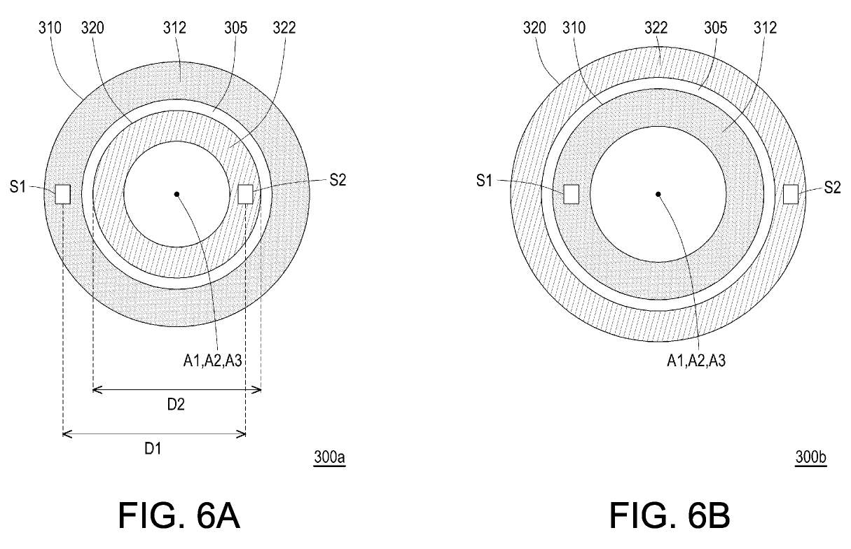

FIGS. 6A, and 6B are front schematic views of wavelength conversion modules in illumination systems according to two other embodiments of the disclosure. In FIGS. 6A, and 6B, wavelength conversion modules 300a and 300b are similar to the wavelength conversion module 300 in FIGS. 1A-1D, and the main differences therebetween are described as follows. In the wavelength conversion modules 300a and 300b, the first wavelength conversion component 310 and the second wavelength conversion component 320 are disposed on the same rotating substrate 305, and a distance from the first wavelength conversion component 310 to a central axis A3 of the rotating substrate 305 is not equal to the distance from the second wavelength conversion component 320 to the central axis A3 of the rotating substrate 305.

Specifically, in the embodiment of FIG. 6A, the wavelength conversion region 312 of the first wavelength conversion component 310 of the wavelength conversion module 300a is radially farther from the central axis A3 (i.e., an outer ring), while the wavelength conversion region 322 of the second wavelength conversion component 320 is radially closer to the central axis A3 (i.e., an inner ring). Additionally, a distance D1 between the light spot S1 formed by the first laser light 211 on the first wavelength conversion component 310 and the light spot S2 formed by the second laser light 221 on the second wavelength conversion component 320 is greater than a diameter D2 of the second wavelength conversion component 320.

However, in the embodiment of FIG. 6B, the wavelength conversion region 312 of the first wavelength conversion component 310 of the wavelength conversion module 300b is radially closer to the central axis A3 (i.e., an inner ring), while the wavelength conversion region 322 of the second wavelength conversion component 320 is radially farther from the central axis A3 (i.e., an outer ring).

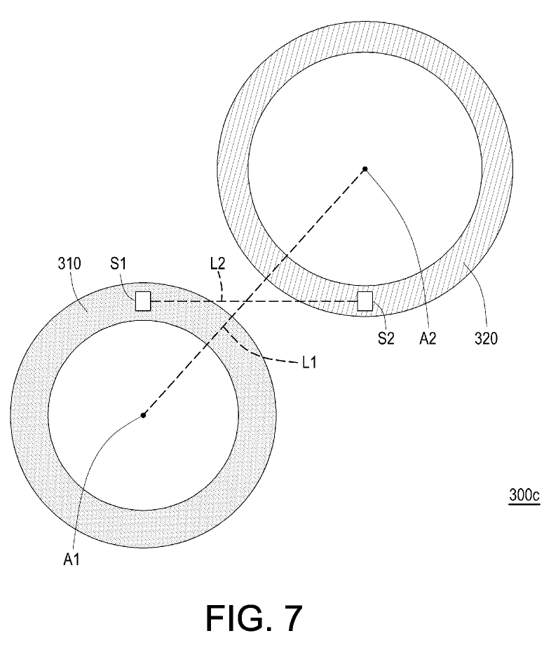

FIG. 7 is a front schematic view of a wavelength conversion module in an illumination system according to yet another embodiment of the disclosure. Referring to FIG. 7, a wavelength conversion module 300c of this embodiment is similar to the wavelength conversion module 300 in FIGS. 1A-1D, and the main differences therebetween are described as follows. In the wavelength conversion module 300c of this embodiment, a connecting line between the central axis A1 of the first wavelength conversion component 310 and the central axis A2 of the second wavelength conversion component 320 is defined as a first connecting line L1. A connecting line between the light spot S1 formed by the first laser light 211 on the first wavelength conversion component 310 and the light spot S2 formed by the second laser light 221 on the second wavelength conversion component 320 is defined as a second connecting line L2. An angle between the first connecting line L1 and the second connecting line L2 is non-zero. In other words, the first wavelength conversion component 310 and the second wavelength conversion component 320 can be offset from each other according to requirements so as to reduce the volume of the illumination system and the projection apparatus.

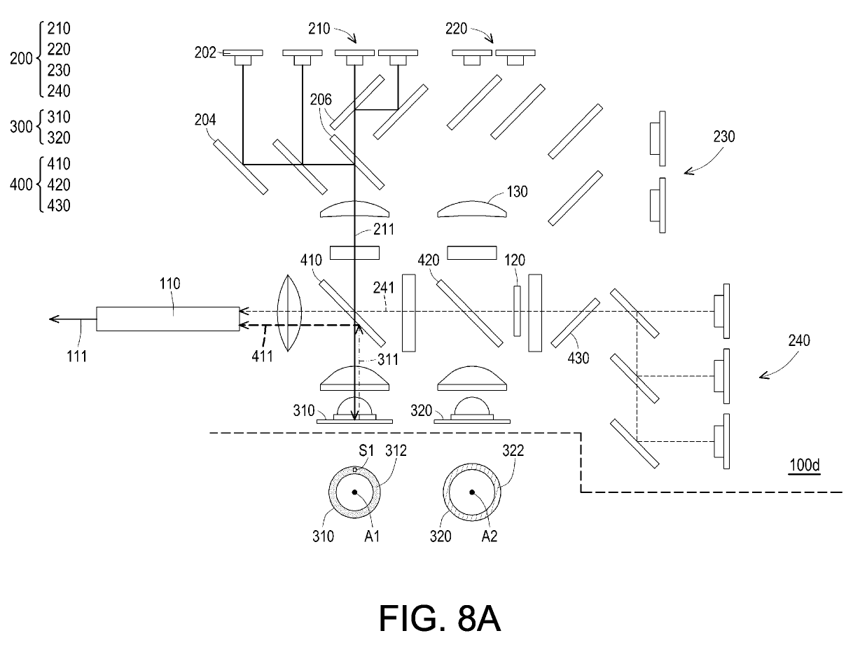

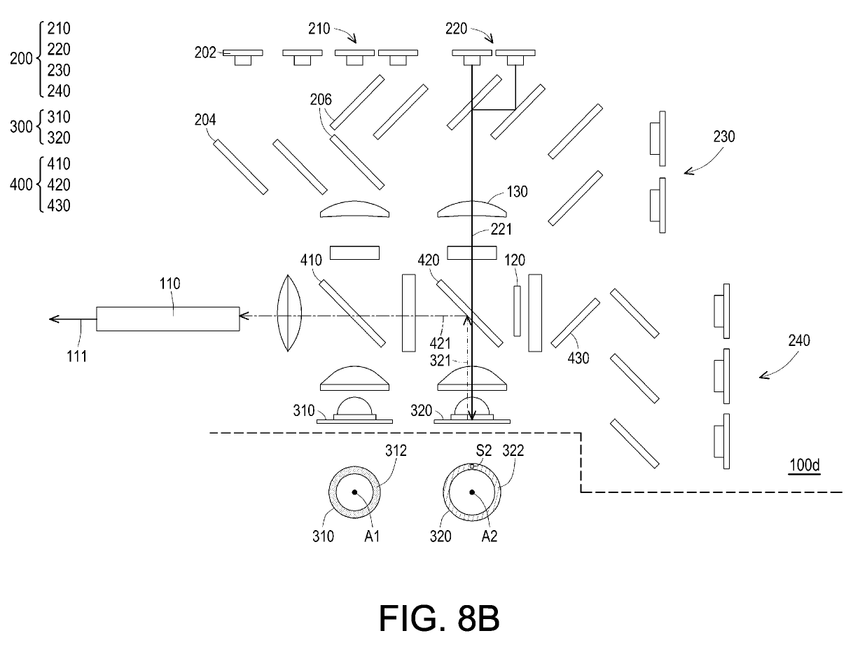

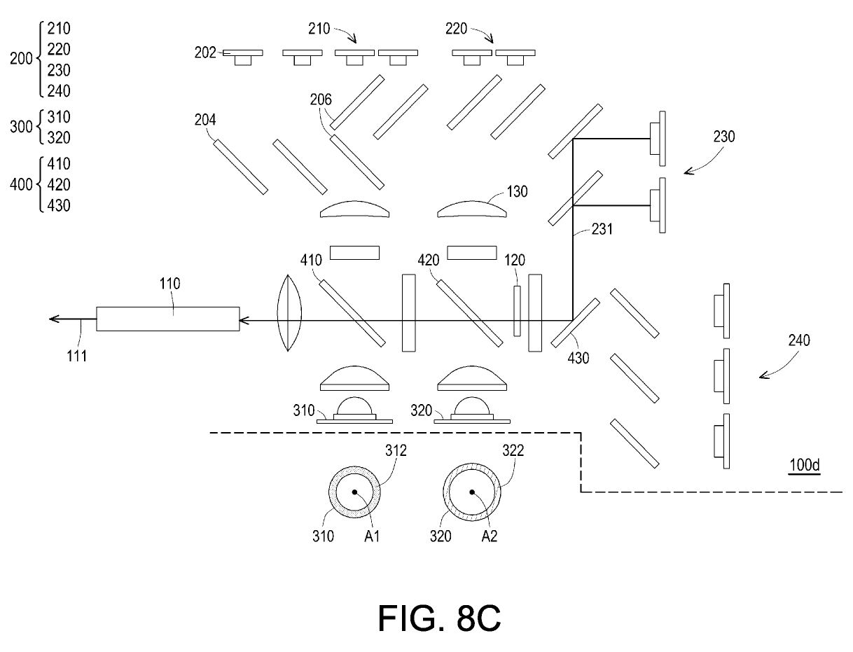

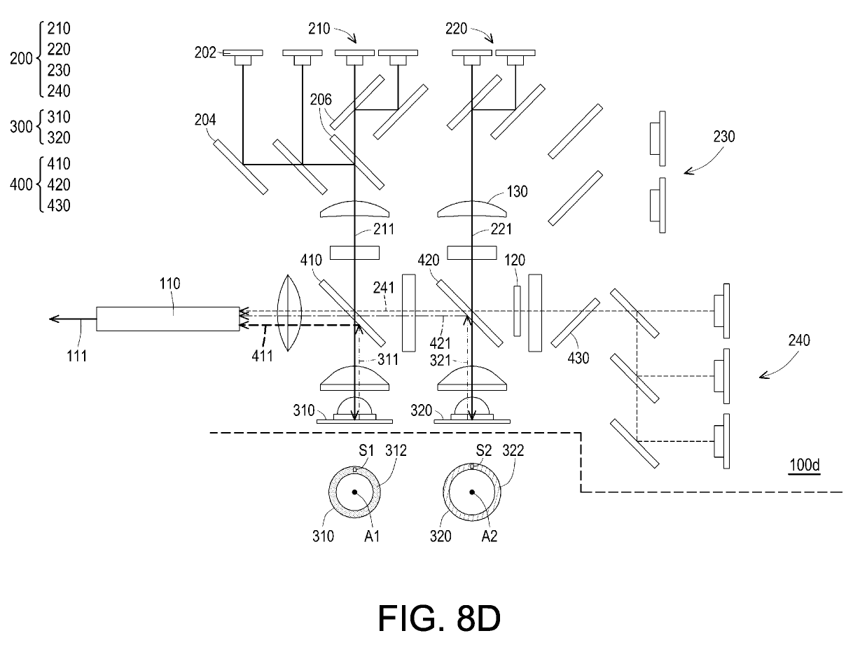

FIGS. 8A,8B,8C, and 8D, and are optical path schematic views of an illumination system according to still another embodiment of the disclosure when the first color light, the second color light, the third laser beam, and the third color light are transmitted to the light homogenizing module, respectively. Referring to FIGS. 8A-8D, an illumination system 100d of this embodiment is similar to the illumination system 100 in FIGS. 1A-1D, and the main differences therebetween are described as follows. In the illumination system 100d of this embodiment, the first wavelength range W1 which is the reflection band of the first dichroic mirror 410 ranges from 583 to 636 nm, and the second wavelength range W2 which is the reflection band of the second dichroic mirror 420 ranges from 491 to 582 nm. Therefore, the first color light 411 generated by filtering through the first dichroic mirror 410 is red, and the second color light 421 generated by filtering through the second dichroic mirror 420 is green. Where the fourth laser light 241 is red, during the timing of the R time interval, the fourth laser module 240 is configured to be turned on simultaneously with the first laser module 210, so that the red fourth laser light 241 and the red first color light 411 are mixed into a red light that is less likely to cause laser speckle. In this embodiment, the wavelength conversion region 312 of the first wavelength conversion component 310 and the wavelength conversion region 322 of the second wavelength conversion component 320 may include the same or different phosphors, and the disclosure is not limited thereto. For example, the wavelength conversion region 312 of the first wavelength conversion component 310 includes yellow phosphor, and the wavelength conversion region 322 of the second wavelength conversion component 320 includes green phosphor.

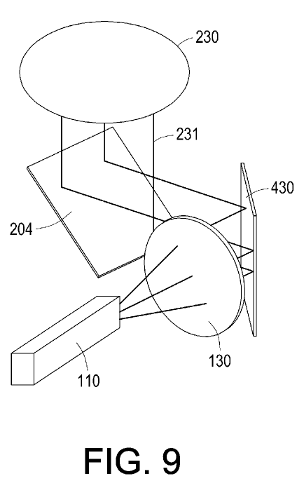

FIG. 9 is a simplified perspective schematic view of a positional relationship of optical paths between the third laser module and the light homogenizing module in an illumination system according to another embodiment of the disclosure. The illumination system of this embodiment is similar to the illumination system in FIGS. 1A-1D, and the main differences therebetween are described as follows. In this embodiment, a transmission path of the third laser light 231 from the third laser module 230 to the light homogenizing module 110 is non-coplanar (does not lie in a single plane). In other words, the optical path may be folded through rotation and translation to reduce the volume occupied by the optical path. Similarly, the optical paths corresponding to the first laser module 210, the second laser module 220, and the fourth laser module 240 may also be designed with rotation and translation similar to the optical path of the aforementioned third laser module 230.

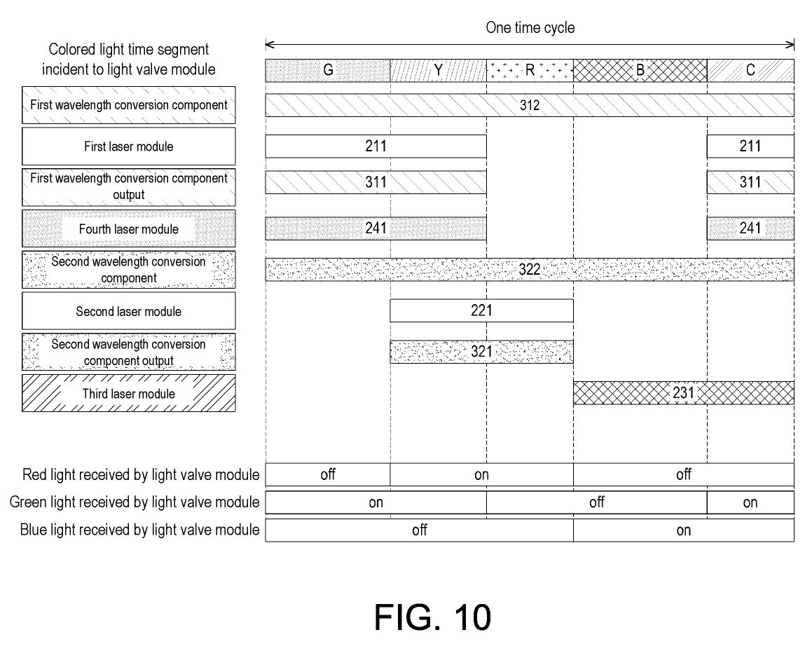

FIG. 10 is a light timing diagram of a projection apparatus according to yet another embodiment of the disclosure. Referring to FIGS. 10, and 1A-1D, the illumination system of the projection apparatus of this embodiment is similar to the illumination system in FIGS. 1A-1D, the light timing diagram thereof is also similar to the light timing diagram of FIG. 5, and the main differences therebetween are described as follows. In the illumination system of this embodiment, the fourth laser light 241 is green. Since the fourth laser light 241 has the same color as the first color light 411, the time interval during which the fourth laser module 240 provides the fourth laser light 241 is the same as the time interval during which the first laser module 210 provides the first laser light 211, so that the green first color light 411 and the green fourth laser light 241 may be mixed into a green light capable of reducing laser speckle. Furthermore, in this embodiment, the first dichroic mirror 410 may have high transmittance for the narrower wavelength range corresponding to the fourth laser light 241, while having high reflectance for the green wavelength range outside the narrower wavelength range, so that the first dichroic mirror 410 may still reflect the green first color light 411 having a higher color purity and may allow the fourth laser light 241 to pass through.

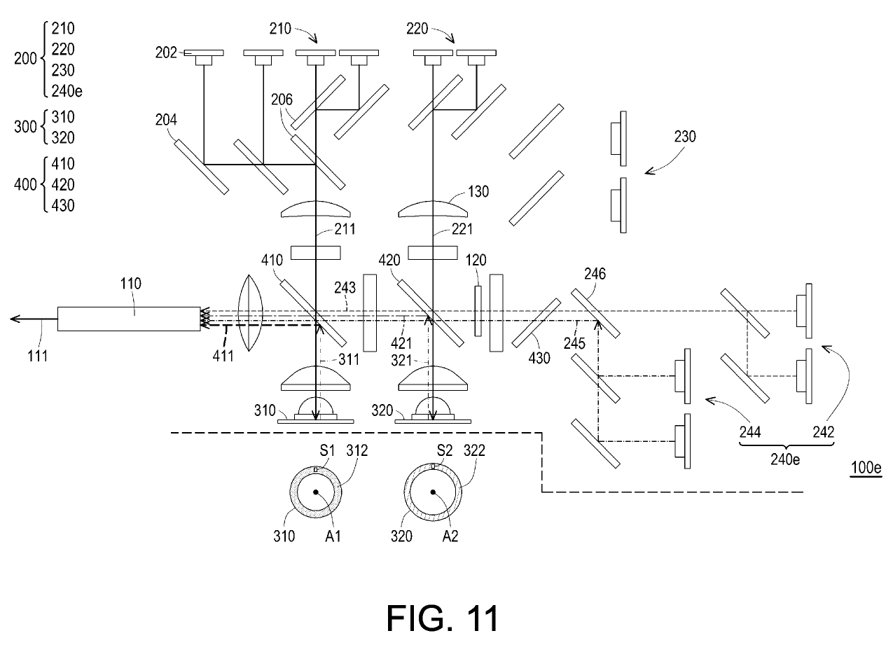

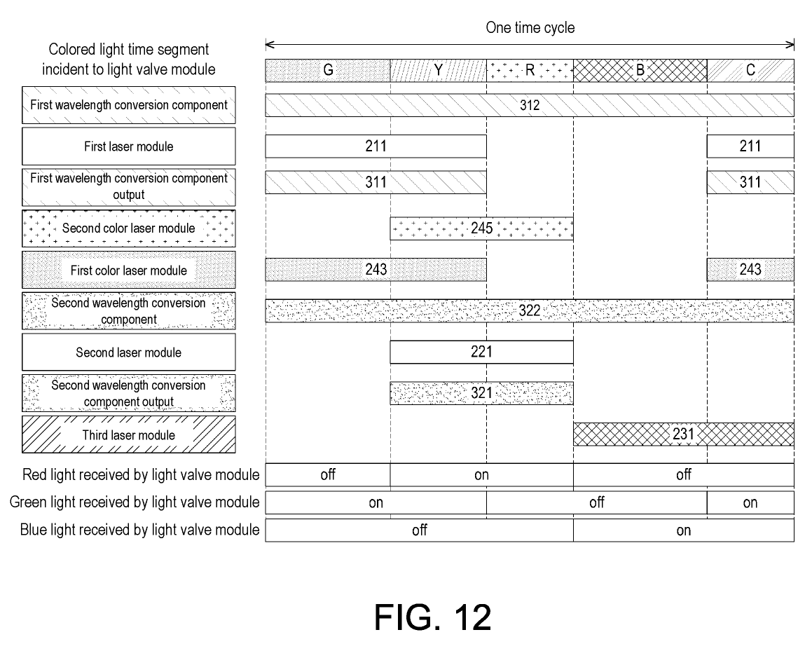

FIG. 11 is an optical path schematic view of an illumination system according to still another embodiment of the disclosure when the third color light is transmitted to the light homogenizing module, and FIG. 12 is a light timing diagram of a projection apparatus employing the illumination system in FIG. 11. Referring to FIGS. 11, and 12, an illumination system 100e of the projection apparatus of this embodiment is similar to the illumination system 100 in FIGS. 1A-1D, the light timing diagram thereof is also similar to the light timing diagram in FIG. 5, and the main differences therebetween are described as follows. In the illumination system 100e of this embodiment, a fourth laser module 240e includes a first color laser module 242 and a second color laser module 244, the first color laser module 242 is configured to provide a first color laser light 243, the second color laser module 244 is configured to provide a second color laser light 245, and the first color laser light 243 and the second color laser light 245 sequentially pass through the second dichroic mirror 420 and the first dichroic mirror 410 and are incident on the light homogenizing module 110. The color of the first color laser light 243 is the same color as a color of the first color light 411, and the second color laser light 245 has the same as a color of the second color light 421. In this embodiment, the time interval during which the first color laser module 242 provides the first color laser light 243 overlaps with the time interval during which the first laser module 210 provides the first laser light 211, and the time interval during which the second color laser module 244 provides the second color laser light 245 overlaps with the time interval during which the second laser module 220 provides the second laser light 221.

In this embodiment, the fourth laser module 240e includes a dichroic mirror 246, disposed in the transmission path of the first color laser light 243 and the second color laser light 245, and is configured to transmit the first color laser light 243 and the second color laser light 245 to the third dichroic mirror 430. The dichroic mirror 246 is configured to reflect one of the first color laser light 243 and the second color laser light 245, and is configured to allow the other of the first color laser light 243 and the second color laser light 245 to pass through, and in the embodiment of FIG. 11, the dichroic mirror 246 is configured to reflect the second color laser light 245, and configured to allow the first color laser light 243 to pass through.

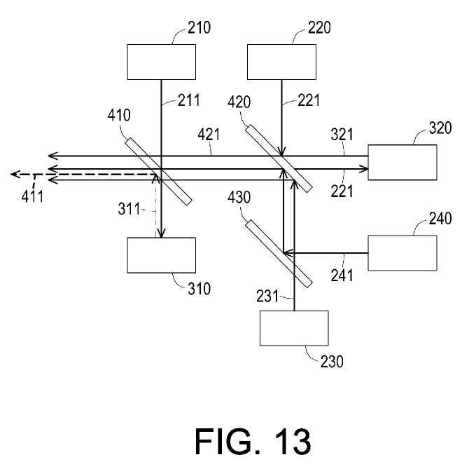

FIG. 13 is a simple schematic view of an optical path of an illumination system according to another embodiment of the disclosure. Referring to FIG. 13, the disclosure is not limited to the first dichroic mirror 410 allowing the first laser light 211 to pass through, filtering the first wavelength conversion light 311 to form the first color light 411, and reflecting the first color light 411 to the light homogenizing module 110. In another embodiment, the first dichroic mirror 410 may reflect the first laser light 211, allow the first wavelength conversion light 311 to be filtered to form the first color light 411, and allow the first color light 411 to pass through to be transmitted to the light homogenizing module 110. The disclosure is not limited to the second dichroic mirror 420 allowing the second laser light 221 to pass through, filtering the second wavelength conversion light 321 to form the second color light 421, and reflecting the second color light 421 to the light homogenizing module 110. In another embodiment, the second dichroic mirror 420 may reflect the second laser light 221, allow the second wavelength conversion light 321 to be filtered to form the second color light 421, and allow the second color light 421 to pass through to be transmitted to the light homogenizing module 110. The disclosure is not limited to the third dichroic mirror 430 reflecting the third laser light 231 and allowing the fourth laser light 241 to pass through. In another embodiment, the third dichroic mirror 430 may allow the third laser light 231 to pass through, and reflect the fourth laser light 241. In the embodiment of FIG. 13, the first dichroic mirror 410 allows the first laser light 211 to pass through, filters the first wavelength conversion light 311 to form the first color light 411, and reflects the first color light 411 to the light homogenizing module 110; the second dichroic mirror 420 reflects the second laser light 221, filters the second wavelength conversion light 321 to form the second color light 421, and allows the second color light 421 to pass through to be transmitted to the light homogenizing module 110; and the third dichroic mirror 430 allows the third laser light 231 to pass through and reflects the fourth laser light 241.

In summary, the illumination system and the projection apparatus of the embodiments of the disclosure have at least one of the advantages as follows. In the illumination system and the projection apparatus of the embodiments of the disclosure, the first color light is produced by employing the first laser module, the first wavelength conversion component, and the first dichroic mirror, and the second color light is produced by employing the second laser module, the second wavelength conversion component, and the second dichroic mirror. Therefore, the first color light, the second color light, and the third laser light may be independently turned on and turned off without being subject to hardware limitations such as motors or color wheels, thereby significantly increasing the color update rate without causing color breaking phenomena. Furthermore, in the illumination system and the projection apparatus of the embodiments of the disclosure, the fourth laser light has the same color as the color of the first color light or the second color light, while the first color light and the second color light are converted by the wavelength conversion components and are filtered out through the first dichroic mirror and the second dichroic mirror respectively, such that no laser speckle occurs. Therefore, by combination of the first color light and the fourth laser light or the combination of the second color light and the fourth laser beam, the speckle phenomenon can be effectively suppressed. Moreover, the first color light filtered out through the first dichroic mirror and the second color light filtered out through the second dichroic mirror may have higher color purity, thereby effectively improving the color gamut coverage.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising: a light source module, a wavelength conversion module, a dichroic module, and a light homogenizing module, wherein
the light source module comprises a first laser module, a second laser module, a third laser module, and a fourth laser module, wherein the first laser module, the second laser module, the third laser module, and the fourth laser module provide a first laser beam, a second laser beam, a third laser beam, and a fourth laser beam, respectively,
the wavelength conversion module comprises a first wavelength conversion component and a second wavelength conversion component, the first wavelength conversion component is disposed on a transmission path of the first laser light and configured to convert the first laser light into first wavelength conversion light, and the second wavelength conversion component is disposed on a transmission path of the second laser light and configured to convert the second laser light into second wavelength conversion light, and
the dichroic module comprises a first dichroic mirror, a second dichroic mirror, and a third dichroic mirror, the first dichroic mirror is disposed on a transmission path of the first laser light from the first laser module to the first wavelength conversion component and configured to reflect one of light in a first wavelength range and light outside the first wavelength range and allow the other to pass through, the second dichroic mirror is disposed on a transmission path of the second laser light from the second laser module to the second wavelength conversion component and configured to reflect one of light in a second wavelength range and light outside the second wavelength range and allow the other to pass through, and the third dichroic mirror is disposed on transmission paths of the third laser light and the fourth laser light and configured to transmit the third laser light and the fourth laser light to the second dichroic mirror,
wherein the first wavelength conversion light is filtered by the first dichroic mirror into a first color light in the first wavelength range, the first dichroic mirror guides the first color light to be incident on the light homogenizing module, the second wavelength conversion light is filtered by the second dichroic mirror into a second color light in the second wavelength range, the second dichroic mirror guides the second color light to be incident on the light homogenizing module, the third laser light and the fourth laser light are sequentially guided by the second dichroic mirror and the first dichroic mirror to be incident on the light homogenizing module, a color of the fourth laser light is the same as a color of the first color light or the second color light, and the light homogenizing module homogenizes the first color light, the second color light, the third laser beam, and the fourth laser light to generate an illumination light.

2. The illumination system as claimed in claim 1, wherein both the third laser module and the fourth laser module are disposed on a same side of the second dichroic mirror.

3. The illumination system as claimed in claim 1, wherein the first laser beam, the second laser beam, and the third laser light have a same central wavelength.

4. The illumination system as claimed in claim 1, wherein the first wavelength range ranges from 491 to 582 nm, the second wavelength range ranges from 583 to 636 nm.

5. The illumination system as claimed in claim 1, wherein the third dichroic mirror is configured to reflect the third laser light from the third laser module, while allowing the fourth laser light from the fourth laser module to pass through.

6. The illumination system as claimed in claim 5, wherein a reflection band of the third dichroic mirror ranges from 435 to 485 nm, and a central wavelength of the fourth laser light is greater than 636 nm.

7. The illumination system as claimed in claim 1, wherein the third dichroic mirror is configured to reflect the fourth laser light from the fourth laser module and allow the third laser light from the third laser module to pass through.

8. The illumination system as claimed in claim 1, wherein the first laser module, the second laser module, and the third laser module are configured to provide the first laser beam, the second laser beam, and the third laser light in different time intervals, respectively.

9. The illumination system as claimed in claim 1, wherein a time interval during which the fourth laser module provides the fourth laser light partially overlaps with a time interval during which the first laser module and the second laser module simultaneously provide the first laser light and the second laser beam, such that the fourth laser beam, the first color light, and the second color light are combined to form a third color light.

10. The illumination system as claimed in claim 1, wherein a time interval during which the third laser module provides the third laser light partially overlaps with a time interval during which the first laser module provides the first laser light or a timing interval during which the second laser module provides the second laser beam, such that the third laser light and the first color light, or the third laser light and the second color light, are combined to form a fourth color light.

11. The illumination system as claimed in claim 1, wherein an overlapping poriton of a spectral range of the first color light and a spectral range of the second color light is less than 15% of the spectral range of the first color light and 15% of the spectral range of the second color light, respectively.

12. The illumination system as claimed in claim 1, wherein each of a transmittance of the first dichroic mirror and a transmittance of the second dichroic mirror for the fourth laser light is greater than 90%.

13. The illumination system as claimed in claim 1, wherein an excitation spectrum of a wavelength conversion region of the first wavelength conversion component is different from an excitation spectrum of a wavelength conversion region of the second wavelength conversion component.

14. The illumination system as claimed in claim 1, wherein a wavelength conversion region of the first wavelength conversion component and a wavelength conversion region of the second wavelength conversion component are both ring-shaped.

15. The illumination system as claimed in claim 14, wherein the first wavelength conversion component and the second wavelength conversion component are disposed on a same rotating substrate, and a distance from the first wavelength conversion component to a central axis of the rotating substrate is not equal to a distance from the second wavelength conversion component to the central axis of the rotating substrate.

16. The illumination system as claimed in claim 15, wherein the wavelength conversion region of the first wavelength conversion component is radially farther from the central axis, the wavelength conversion region of the second wavelength conversion component is radially closer to the central axis, and a distance between a light spot generated by the first laser light on the first wavelength conversion component and a light spot generated by the second laser light on the second wavelength conversion component is greater than a diameter of the second wavelength conversion component.

17. The illumination system as claimed in claim 1, wherein a connecting line between a central axis of the first wavelength conversion component and a central axis of the second wavelength conversion component is defined as a first connecting line, a connecting line between a light spot formed by the first laser light on the first wavelength conversion component and a light spot formed by the second laser light on the second wavelength conversion component is defined as a second connecting line, and an angle between the first connected line and the second connected line is non-zero.

18. The illumination system as claimed in claim 1, wherein a transmission path of the third laser light from the third laser module to the light homogenizing module is non-coplanar.

19. The illumination system as claimed in claim 1, wherein the fourth laser module comprises a first color laser module and a second color laser module, the first color laser module is configured to provide a first color laser beam, the second color laser module is configured to provide a second color laser beam, and the first color laser light and the second color laser light sequentially pass through the second dichroic mirror and the first dichroic mirror to be incident on the light homogenizing module, wherein a color of the first color laser light is the same as a color of the first color light, and a color of the second color laser light is the same as a color of the second color light.

20. A projection apparatus, comprising: an illumination system, a light valve module, and a lens module, wherein
the illumination system is configured to provide an illumination light,
the light valve module is disposed on a transmission path of the illumination light and is configured to convert the illumination light into an image light beam, and
the lens module is disposed on a transmission path of the image light and is configured to project the image light outside the projection apparatus,
wherein the illumination system comprises a light source module, a wavelength conversion module, a dichroic module, and a light homogenizing module,
the light source module comprises a first laser module, a second laser module, a third laser module, and a fourth laser module, wherein the first laser module, the second laser module, the third laser module, and the fourth laser module provide a first laser beam, a second laser beam, a third laser beam, and a fourth laser beam, respectively,
the wavelength conversion module comprises a first wavelength conversion component and a second wavelength conversion component, the first wavelength conversion component is disposed on a transmission path of the first laser light and configured to convert the first laser light into a first wavelength conversion light, and the second wavelength conversion component is disposed on a transmission path of the second laser light and configured to convert the second laser light into a second wavelength conversion light; and
the dichroic module comprises a first dichroic mirror, a second dichroic mirror, and a third dichroic mirror, the first dichroic mirror is disposed on a transmission path of the first laser light from the first laser module to the first wavelength conversion component and configured to reflect one of light in a first wavelength range and light outside the first wavelength range and allow the other to pass through, the second dichroic mirror is disposed on a transmission path of the second laser light from the second laser module to the second wavelength conversion component and configured to reflect one of light in a second wavelength range and light outside the second wavelength range and allow the other to pass through, and the third dichroic mirror is disposed on transmission paths of the third laser light and the fourth laser light and configured to transmit the third laser light and the fourth laser light to the second dichroic mirror,
wherein the first wavelength conversion light is filtered by the first dichroic mirror into a first color light in the first wavelength range, the first dichroic mirror guides the first color light to be incident on the light homogenizing module, the second wavelength conversion light is filtered by the second dichroic mirror into a second color light in the second wavelength range, the second dichroic mirror guides the second color light to be incident on the light homogenizing module, the third laser light and the fourth laser light are sequentially guided by the second dichroic mirror and the first dichroic mirror to be incident on the light homogenizing module, a color of the fourth laser light is the same as a color of the first color light or the second color light, and the light homogenizing module homogenizes the first color light, the second color light, the third laser beam, and the fourth laser light to generate the illumination light.
